(19) United States
(12) Patent Application Publication
(10) Pub. No.: US 2007/0202416 A1
(43) Pub. Date: Aug. 30, 2007

(54) Electrochemical cells having an electrolyte with swelling reducing additives

(76) Inventors: Kaimin Chen, New Brighton, MN (US); Craig L. Schmidt, Eagan, MN (US)

Correspondence Address: MEDTRONIC, INC., 710 MEDTRONIC PARKWAY NE, MINNEAPOLIS, MN, 55432-9924, US

(21) Appl. No.: 11/364,669

(22) Filed: Feb. 28, 2006

(51) Int. Cl. H01M 10/40; H01M 4/00; H01M 4/58; H01M 10/48; H01M 4/48; H01M 4/34; H01M 4/54

(52) U.S. Cl. 429/326; 429/231.95; 429/231.6; 429/219; 429/231.7

(57) ABSTRACT

According to one aspect of the present invention, an electrochemical cell is provided. The electrochemical cell includes a housing, an anode and a cathode within the housing, and an electrolytic solution within the housing and contacting the anode and the cathode. The electrolytic solution includes a solute and a solvent. The solute includes at least one of tetrafluoroborate and an organic cation.

### TECHNICAL FIELD

The present invention generally relates to an electrochemical cell, or battery, and more particularly relates to an electrolyte for use in electrochemical cells.

### BACKGROUND

Modern medical devices, such as defibrillators, pacemakers, neurostimulators, and drug delivery devices, have demanding power requirements. For example, defibrillator devices continuously monitor the electrical activity of a patient's heart, detect ventricular fibrillation, and in response, deliver appropriate electrical pulses, or shocks, to the heart to restore a normal heart beat. Typically, the pulses from a defibrillator are generated by capacitors and may need to be between 30 and 35 joules in order to achieve the desired effect. In order to deliver the pulses in a timely fashion, the capacitors must be charged in just a few seconds. Therefore, batteries used in such devices must have what is known as “high rate capability,” possess low self-discharge to have a sufficiently long useful life, and be highly reliable. Additionally, because such devices may be surgically implanted into the patient, the battery must be as small as possible.

Lithium batteries are now commonly used as power sources for such medical devices. These batteries, or electrochemical cells, generally include a lithium anode and a cathode which often contains carbon monofluoride and/or silver vanadium oxide. The anode and the cathode are typically enveloped in an electrolyte (e.g., an electrolytic solution) containing a solute (typically a lithium salt, such as LiAsF₆) and a solvent mixture (e.g., propylene carbonate (PC), dimethoxyethane (DME), and/or diglyme (DG)).

During discharge, the lithium batteries typically experience a significant amount of swelling. As a result, the space made available for the batteries in the medical devices must be slightly larger than the normal, non-swollen size of the battery, thereby increasing the overall size of the devices. Additionally, as the amount of lithium salt in the electrolytic solution increases beyond the optimum concentration, the conductivity of the solution is adversely affected.

Accordingly, it is desirable to provide an electrochemical cell which experiences a reduced amount of swelling during discharge. In addition, it is desirable to provide an electrochemical cell with an electrolytic solution that provides improved conductivity. Furthermore, other desirable features and characteristics of the present invention will become apparent from the subsequent detailed description of the invention and the appended claims, taken in conjunction with the accompanying drawings and this background of the invention.

### BRIEF SUMMARY

An electrochemical cell is provided with reduced swelling during operation. The electrochemical cell comprises a housing, an anode and a cathode within the housing, and an electrolytic solution within the housing and contacting the anode and the cathode, the electrolytic solution comprising a solute and a solvent, the solute comprising at least one of tetrafluoroborate and an organic cation.

### BRIEF DESCRIPTION OF THE DRAWINGS

The present invention will hereinafter be described in conjunction with the following drawing figures, wherein like numerals denote like elements, and

FIG. 1 is an exploded isometric view of a partially completed battery assembly;

FIG. 2 is an exploded view of the battery assembly illustrated in FIG. 1 showing additional components thereof;

FIG. 3 is a table illustrating the reduction in the swelling of an electrochemical cell achieved in accordance with one embodiment of the present invention; and

FIG. 4 is a table illustrating the reduction in the swelling of an electrochemical cell achieved in accordance with another embodiment of the present invention.

### DETAILED DESCRIPTION

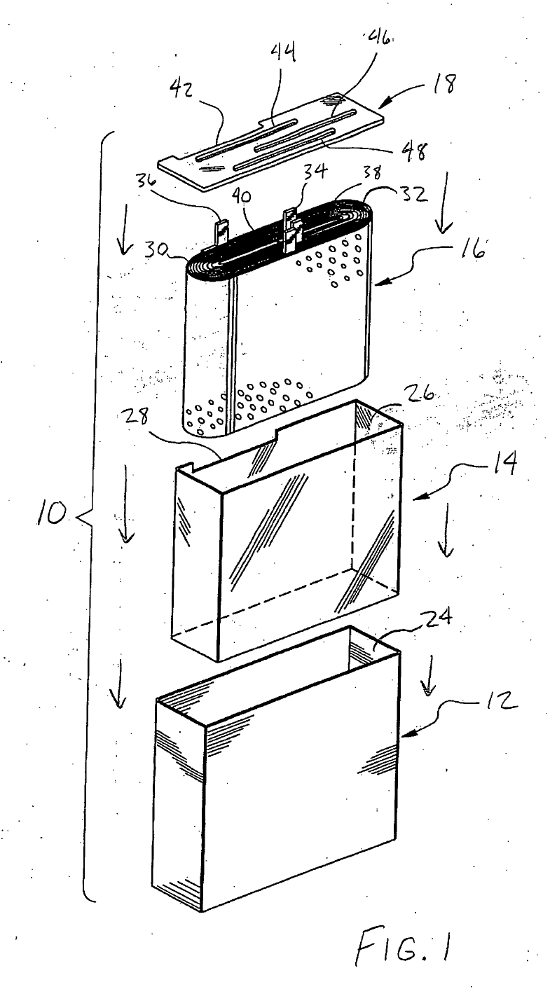

The following detailed description of the invention is merely exemplary in nature and is not intended to limit the invention or the application and uses of the invention. Furthermore, there is no intention to be bound by any theory presented in the preceding background of the invention or the following detailed description of the invention. It should also be noted that FIGS. 1-4 are merely illustrative and may not be drawn to scale.

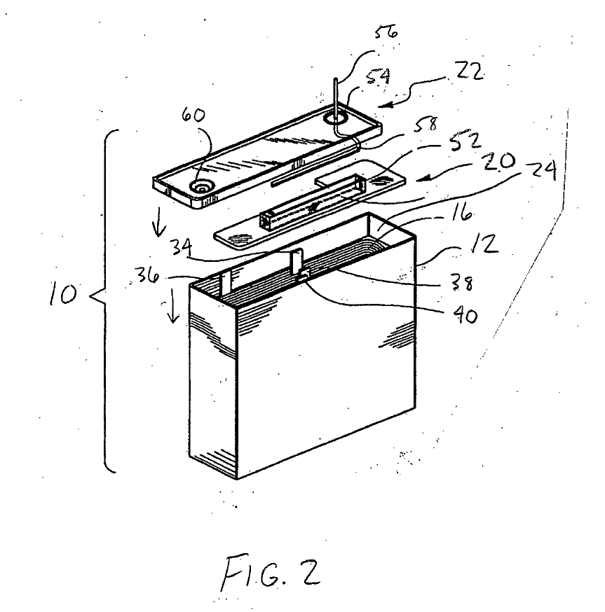

FIG. 1 and FIG. 2 illustrate a battery, or electrochemical cell, according to one embodiment of the present invention. The electrochemical cell includes a housing with an anode and a cathode contained therein. The anode comprises lithium, and the cathode comprises at least one of carbon monofluoride (CFₓ), silver vanadium oxides (SVO), such as Ag₂V₄O₁₁, manganese oxide (MnO₂), vanadium oxides (such as V₂O₅), copper vanadium oxide, and lithium vanadium oxide (such as LixV₃O₈). The housing is filled with an electrolytic solution comprising a solute and a solvent. The solute includes first and second compounds. The first compound is a lithium salt, and the second compound includes an anion and a cation. The anion is tetrafluoroborate (BF₄—) and the cation is an organic cation. The second compound reduces the swelling of the battery during discharge.

FIGS. 1 and 2 are exploded isometric views of a battery assembly 10. The battery assembly 10 includes a case 12, a case liner 14, an electrode assembly 16, a coil insulator 18, a pin insulator 20, and a case cover 22.

Referring to FIG. 1, the case 12, or housing, is substantially rectangular in shape and has a length of approximately 20 mm, a width of approximately 5 mm, and a height of approximately 10 mm. The case 12 is preferably made of stainless steel or titanium and partially encloses, or includes, an electrode cavity 24, which extends substantially the entire length, width, and height of the case 12. As illustrated, the case liner 14 is substantially the same size and shape as the electrode cavity 24 of the case 12. The case liner 14 includes an electrode pocket 26 and is preferably made from a polyolefin polymer or a fluoropolymer, such as polytetrafluoroethylene (PTFE) or polyethylenetetrafluoroethylene (PETFE). In the embodiment illustrated in FIG. 1, the case liner also includes a case liner notch 28 along an upper edge of one side thereof.

The electrode assembly 16 includes an elongated anode 30 and an elongated cathode 32 wound, or coiled, together such that the electrode assembly 16 has a size and shape that is similar to the size and shape of the electrode pocket 26 within the case liner 14. In one embodiment of the present invention, the anode 30 is made of lithium and the cathode 32 is made of porous, or fibrous, carbon monofluoride (CFₓ). As will be appreciated by one skilled in the art, the cathode may also include non-fibrous CFₓ, silver vanadium oxide (SVO), manganese dioxide (MnO₂), copper vanadium oxide, vanadium oxides (such as V₂O₅), and lithium vanadium oxide (such as LiₓV₃O₈) and may be what is known as a “hybrid cathode.” Although not specifically illustrated, the anode 30 and the cathode 32 may be pressed onto a metal current collector, which may be made of, for example, nickel or titanium, and enveloped with a separator of microporous material such as polyethylene, polypropylene, or other suitable material. The electrode assembly 16 also includes anode connector tabs 34 and 36 connected to the anode 30 and cathode connector tabs 38 and 40 connected to the cathode 32. As shown in FIG. 1, the anode connector tabs 34 and 36 and the cathode connector tabs 38 and 40 extend from an upper surface of the electrode assembly 16.

Still referring to FIG. 1, the coil insulator 18 is substantially rectangular in shape with a length and width that are similar to the length and width of the case 12. The coil insulator 18 includes a coil insulator notch 42 along an edge thereof and slots 44, 46, and 48, which extend completely therethrough at a central portion thereof. In a preferred embodiment, the coil insulator 18 is made of the same material as the case liner 44.

The battery assembly 10 is assembled by inserting the coil insulator 18, the electrode assembly 16, and the case liner 14 into the electrode cavity 24 of the case 12, as indicated by the arrows in FIG. 1. The coil insulator 18 is pressed onto the upper surface of the electrode assembly 16 such that the anode connector tabs 34 and 36 are received by the slot 44 and the coil insulator notch 42, respectively, and the cathode connector tabs 38 and 40 are received by the slots 46 and 48, respectively. Although not specifically shown, the electrode assembly 16 is inserted into the electrode pocket 26 of the case liner 14 such that the upper edge of the case liner 14 extends past the upper surface of the electrode assembly 16. The case liner 14, along with the electrode assembly 16 and the coil insulator 18, are then fit into the electrode cavity 24 of the case 12.

Referring now to FIG. 2, which illustrates the battery assembly 10 after the assembly described above, the pin insulator 20 includes a raised portion 50 having an aperture 52 therein. The case cover 22 is also substantially rectangular and has an insulated feedthrough opening 54 and a feedthrough pin 56 extending through the feedthrough opening 54 with a bend 58 therein. The case cover 22 also includes a fill port 60.

As indicated by the arrows in FIG. 2, the battery assembly 10 is further assembled by inserting the feedthrough pin 56 into the aperature 52 of the raised portion 50 and pressing the case cover 22 against the pin insulator 20. The electrode cavity 24 is closed with the case cover 22 so that the pin insulator 20 is adjacent to the electrode assembly 16 within the electrode cavity. As will be appreciated by one skilled in the art, the feedthrough pin 56 is welded to the cathode connector tabs 38 and 40 and the anode connector tabs 34 and 38 are bent appropriately and welded to an inner surface of the case 12 such that the case 12 becomes one terminal, or contact, for the battery assembly 10 and the feedthrough pin 56 becomes a second terminal or contact for the battery assembly 10. The case cover 22 may be welded to the case 12 to seal the electrode assembly 16 within the case 12.

An electrolytic solution is then introduced into the electrode cavity 24 through the fill port 60 in the case cover 22 to envelope the components within the electrode cavity, including the anode and the cathode, to form an electrochemical cell. As will be appreciated by one skilled in the art, the electrolytic solution includes a solute and a solvent. Solvents used can be organic solvents such as, for example, 3-methyl-2-oxazolidone, sulfolane, tetrahydrofuran, methyl-substituted tetrahydrofuran, 1,3-dioxolane, propylene carbonate (PC), ethylene carbonate, diethyl carbonate (DEC), dimethyl carbonate (DMC), gamma-butyrolactone, ethylene glycol sulfite, dimethylsulfite, dimethyl sulfoxide or mixtures thereof and also, for example, low viscosity co-solvents such as dimethoxyethane (DME), diglyme (DG) and other similar solvents.

In one embodiment of the present invention, the solute includes first and second compounds. The first compound is a simple or double salt, or a mixture thereof, such as a lithium salt. Examples of such lithium salts are lithium hexafluoroarsenate (LiAsF₆), lithium hexafluorophosphate (LiPF₆), lithium imide (Li(CF₃SO₂)₂N), lithium tris(trifluoromethane sulfonate) carbide (Li(CF₃SO₂)₃C), lithium tetrafluoroborate (LiBF₄), lithium triflate (LiCF₃SO₃), and lithium perchlorate (LiClO₄). Preferably, the concentration of the first salt within the solvent is approximately 1.0 M.

The second compound, or additive, is a salt and, as is commonly understood, includes an anion and a cation. In a preferred embodiment of the present invention, the anion is tetrafluoroborate (BF₄⁻). The cation in the second compound is an organic cation such as a quaternary amine (either an alkylamine or an arylamine, or a mixed amine). The alkylamine may be, for example, tetramethylammonium (TMA), tetraethylammonium (TEA), tetra(n- or iso-) propylammonium (TPA), and/or tetra(n- or t-)butylammonium (TBA). In one embodiment, the concentration of the second compound within the solvent is between 0.1M and 1.5M, preferably approximately 1.0M.

In use, the battery assembly 10 illustrated in FIGS. 1 and 2 is installed into, for example, a medical device such as an intercardiac device such as a defibrillator or a pace maker, or a drug delivery device, as is commonly understood in the art. As previously mentioned, the case 12 acts as one terminal of the battery assembly 10 and the feedthrough pin 56 acts as a second terminal of the battery assembly 10. The case 12 and the feedthrough pin 56 are thus electrically connected to the electronic components within the chosen device, and the battery assembly 10 provides the necessary power to the device. The battery assembly 10 may provide, for example, between 1 microwatt and several watts of power. During operation, because of the addition of the second compound or salt to the electrolytic solution, the swelling experienced by the cathode is minimized.

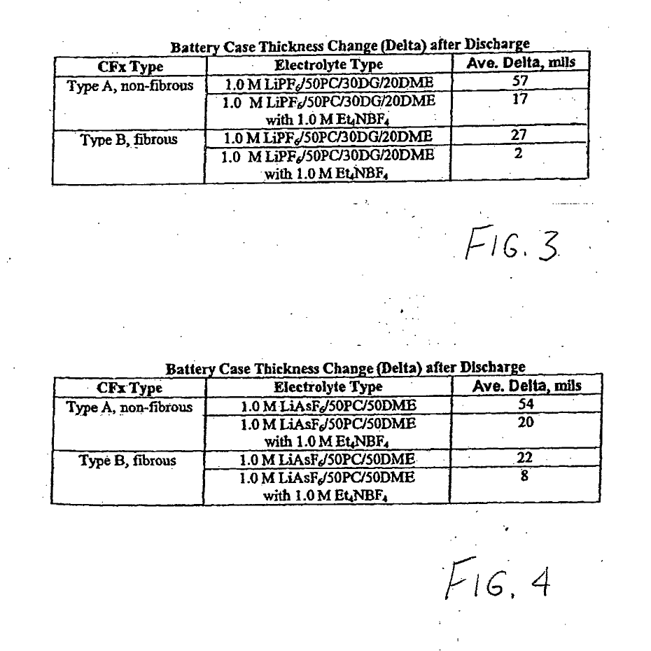

FIGS. 3 and 4 illustrate the results of several experiments which demonstrate the reduction of swelling in the electrochemical cells constructed in accordance with aspects of the present invention. As shown in FIG. 3, a battery using a hybrid cathode of SVO/CFx with non-fibrous CFₓ (i.e., CFₓ Type A) in a solution (i.e., Elelctrolyte Type) of 1.0M LiPF₆ in a solvent of 50% propylene carbonate (PC), 30% diglyme (DG), and 20% dimethoxyethane (DME) experienced approximately 57 mils of swelling as measured at the case of the battery after the battery was accelerately discharged (i.e., Ave. Delta, mils). The swelling experienced by the same battery was reduced from 57 mils to 17 mils when 1.0M tetraethylammonium tetrafluoroborate (Et₄NBF₄) was added to the solution. Still referring to FIG. 3, a battery using a hybrid cathode of SVO/CFx with fibrous CFₓ (i.e., CFx type B) in the solution of 1.0M LiPF₆ in a solvent of 50% propylene carbonate (PC), 30% diglyme (DG), and 20% dimethoxyethane (DME) experienced approximately 27 mils of swelling. The swelling was reduced from 27 mils to 2 mils when 1.0M Et₄NBF₄ was added to the solution.

Referring to FIG. 4, a battery using a hybrid cathode of SVO/CFx with non-fibrous CFₓ cathode in a solution of 1.0M LiAsF₆ in a solvent of 50% PC and 50% DME experienced approximately 54 mils of swelling at the case after accelerated discharge. The swelling was reduced from 54 mils to 20 mils when 1.0M Et₄NBF₄ was added to the solution. As shown in FIG. 4, a battery using a hybrid cathode of SVO/CFx with fibrous CFₓ cathode in the solution of 1.0M LiAsF₆ in a solvent of 50% PC and 50% DME experienced approximately 22 mils of swelling. The swelling was reduced from 22 mils to 8 mils when 1.0M Et₄NBF₄ was added to the solution.

The addition of the second compound or salt minimizes the amount of swelling that is experienced by the cathode during discharge. Therefore, the battery assembly does not need to be constructed to allow for extra room for the battery assembly to swell during operation. Thus, the overall size of the battery assembly, as well as the particular medical device, is reduced. Another advantage is that the conductivity of the electrolytic solution is not compromised by the addition of additional salt. A further advantage is that the addition of the second compound helps to maintain a proper Li⁺ concentration in the electrolytic solution.

It should be understood that the battery assembly 10 described above is only one example of a battery which could utilize the additives described above. Other embodiments may include structures with different sizes and shapes and varying chemical compositions.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. An electrochemical cell comprising:
a housing;
an anode within the housing;
a cathode within the housing; and
an electrolytic solution within the housing and contacting the anode and the cathode, the electrolytic solution comprising a solute and a solvent, the solute comprising at least one of tetrafluoroborate and an organic cation.

2. The electrochemical cell of claim 1, wherein the solute comprises tetrafluoroborate and the organic cation.

3. The electrochemical cell of claim 2, wherein the organic cation is a quaternary amine.

4. The electrochemical cell of claim 3, wherein the anode comprises lithium.

5. The electrochemical cell of claim 4, wherein the cathode comprises at least one of carbon fluoride, silver vanadium oxide, magnesium oxide, vanadium oxide, copper vanadium oxide, and lithium vanadium oxide.

6. The electrochemical cell of the claim 5, wherein the cathode comprises carbon monofluoride.

7. The electrochemical cell of claim 6, wherein the quaternary amine is an alkylamine.

8. The electrochemical cell of claim 7, wherein the quaternary amine comprises at least one of tetramethylamine, tetraethylamine, tetra(n- or iso-) propylamine, and tetra(n- or t-)butylamine.

9. The electrochemical cell of claim 8, wherein the solute further comprises at least one of lithium hexafluoroarsenate, lithium hexafluorophosphate, lithium imide, lithium tris(trifluoromethane sulfonate) carbide, lithium tetrafluoroborate, lithium triflate, and lithium perchlorate.

10. The electrochemical cell of claim 9, wherein the solvent comprises at least one of propylene carbonate, diethylcarbonate, dimethylcarbonate, dimethoxyethane, and diglyme.

11. An electrochemical cell comprising:
a housing;
an anode within the housing and comprising lithium;
a cathode within the housing and comprising carbon monofluoride; and
an electrolytic solution within the housing and contacting the anode and the cathode comprising a solute and a solvent, the solute comprising an anion and an organic cation.

12. The electrochemical cell of claim 11, wherein the organic cation is a quaternary amine and the quaternary amine comprises at least one of tetramethylamine, tetraethylamine, tetrapropylamine, and tetrabutylamine.

13. The electrochemical cell of claim 12, wherein the anion comprises tetrafluoroborate.

14. The electrochemical cell of claim 13, wherein the solute further comprises at least one of lithium hexafluoroarsenate, lithium hexafluorophosphate, lithium imide, lithium tris(trifluoromethane sulfonate) carbide, lithium tetrafluoroborate, lithium triflate, and lithium perchlorate and the solvent comprises at least one of propylene carbonate, dimethylcarbonate, diethylcarbonate, diglyme, and dimethoxyethane.

15. The electrochemical cell of claim 14, wherein the cathode further comprises at least one of silver vanadium oxide, magnesium oxide, vanadium oxide, copper vanadium oxide, and lithium vanadium oxide.

16. An electrochemical cell comprising:
a housing;
an anode within the housing and comprising lithium;
a cathode within the housing and comprising carbon monofluoride; and
an electrolytic solution contacting the anode and the cathode comprising a solute and a solvent, the solute comprising a plurality of anions and a plurality of cations, the plurality of anions comprising tetrafluoroborate and the plurality of cations comprising an organic cation.

17. The electrochemical cell of claim 16, wherein the organic cation is a quaternary amine.

18. The electrochemical cell of claim 17, wherein the quaternary amine is a alkylamine and the quaternary amine comprises at least one of tetramethylamine, tetraethylamine, tetrapropylamine, and tetrabutylamine.

19. The electrochemical cell of claim 18, wherein the concentration of the quaternary amine in the electrolytic solution is between 0.5 and 1.5 M.

20. The electrochemical cell of claim 19, wherein the solute further comprises at least one of lithium hexafluoroarsenate, lithium hexafluorophosphate, lithium imide, lithium tris(ttrifluoromethane sulfonate) carbide, lithium tetrafluoroborate, lithium triflate, and lithium perchlorate and the solvent comprises at least one of propylene carbonate, dimethylcarbonate, diethylcarbonate, diglyme, and dimethoxyethane.
